(19) United States
(12) Patent Application Publication
(10) Pub. No.: US 2010/0052315 A1
(43) Pub. Date: Mar. 4, 2010

(54) QUICK CONNECTOR COUPLING WITH LATERAL STABILIZATION

(75) Inventors: Jim Kerin, Gross Pointe Woods, MI (US); Richard M. Pepe, Macomb, MI (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(73) Assignee: TI Group Automotive Systems, LLC, Warren, MI (US)

(21) Appl. No.: 12/547,548

(22) Filed: Aug. 26, 2009

Related U.S. Application Data
(60) Provisional application No. 61/092,572, filed on Aug. 28, 2008.

(51) Int. Cl. F16L 55/00; F16L 13/04

(52) U.S. Cl. 285/148.21; 285/114

(57) ABSTRACT

A quick connector coupling for use with a fluid line includes a connector body defining a through bore defining an axially extending stabilization ring support surface forward of an entrance opening at the male reception end. The male member is a tube defining a generally cylindrical sealing surface, with radially directed upset at a given distance from the free end of the tube and a rearward cylindrical surface rearward of the upset A retainer is adapted to releasably secure the tube within the connector body. A stabilization ring resides between the axially extending stabilization ring support surface and the rearward cylindrical surface of the tube. In one form, the stabilization ring is secured to the tube to resist rotation relative to the body.

### CROSS-REFERENCE TO RELATED APPLICATIONS

This patent application claims the benefit of U.S. Provisional Patent Application No. 61/092,572, filed Aug. 28, 2008, which is incorporated herein in its entirety by reference.

### BACKGROUND OF THE DISCLOSURE

This invention relates to fluid line systems which include quick connector couplings, and more particularly to a quick connector coupling with axial stabilization between associated coupling components.

In automotive and other fields, quick connector couplings, which generally include a male member received and sealingly retained in a female connector body, are often utilized to provide a fluid connection between two components or conduits, thus establishing a fluid line between the two components. Use of quick connector couplings is advantageous in that a sealed and secured fluid line may be established with a minimum amount of time and expense.

A number of methods and mechanisms exist for securing the male member and female connector body of a quick connector coupling. One type of retention mechanism involves use of a retainer inserted through slots formed in the exterior of the connector body. Beams extending through the slots are positioned in abutting contact between the male member upset and the rearward surfaces defining the slots, to prevent withdrawal of the tube. Such retainers, they are often referred to as “horseshoe” retainers. Examples of this type of coupling are found in U.S. Pat. Nos. 6,846,021 and 7,390,025.

In such couplings, the tube is unsupported except for piloting contact between the end of the tube and a tube receiving portion of the bore, spaced forward of the entrance opening. Lateral forces on the tube, that is, transverse to the axial extent of the coupling, can degrade the integrity of the seal between the tube and body increasing permeation losses. Also, the inserted tube end form is rotatable within the coupling body.

### SUMMARY OF THE DISCLOSURE

In one embodiment, the coupling of the present disclosure includes a stabilization ring interposed between the connector body and the tube at the entrance opening. The stabilization ring may be made of a rigid material, such as aluminum or plastic. The stabilization ring may be rigidly connected around the tubular portion of the male member, for example, by expansion of the tube within the stabilization ring.

The stabilization ring is removably received in the retainer portion of the coupling body at the entrance opening and coacts with the outer surface of the tube to provide lateral support relative to the longitudinal extent of the tube. The stabilization ring improves side-load performance between the tube and connector body. Maintaining the body and tube in axial alignment reduces side load on the internal fluid seal reducing permeation losses.

The stabilization ring may also resist relative rotational movement between the body bore and outer surface of the tube about the longitudinal axis of the tube. Such minimization of relative motion ensures a robust seal to further resist permeation loss. It also permits specific rotational orientation of the tube or male member relative to the connector coupling body.

### BRIEF DESCRIPTION OF THE SEVERAL VIEWS OF THE DRAWINGS

FIG. 1 is an exploded perspective view of a quick connector coupling embodying a stabilization ring illustrative of the principles of the present disclosure.

FIG. 2 is a perspective view of the quick connector coupling of FIG. 1 in an assembled condition.

FIG. 3 is a cross sectional side view of the assembled quick connector coupling of FIG. 2 illustrating the principles of the present disclosure.

FIG. 4 is a cross-sectional side view of the body of the quick connector coupling of FIGS. 1-3.

FIG. 5 is a front view of the quick connector coupling of FIGS. 1-3.

FIG. 6 is a front view of the stabilization ring of the quick connector coupling of FIGS. 1-3.

FIG. 7 is a sectional side view of the stabilization ring illustrated in FIG. 6 taken along the line 7-7 of FIG. 6.

FIG. 8 is a side sectional view of the male member portion of the quick connector coupling of FIGS. 1 to 3 illustrating the stabilization ring attached to the tube in relation to the tube upset.

FIG. 9 is a front view of an alternate embodiment of the stabilization ring in accordance with the disclosure.

FIG. 10 is a front view of an alternate embodiment of the stabilization ring in accordance with the disclosure.

FIG. 11 is a perspective view of a tube illustrating a modified form of the disclosure.

### DETAILED DESCRIPTION OF THE DRAWINGS

The quick connector coupling of the present disclosure is illustrated in connection with a fluid line system. It is shown as a releasable connection between a rigid tube and other fluid carrying components, in particular a flexible hose. However, the coupling has numerous other applications where a fluid tight, but releasable connection is desired, such as connection of rigid elements of a fluid path, whether pressurized, or unpressurized. Examples include automotive vehicle fuel delivery systems or automotive air conditioning systems. One example of a releasable fluid connector coupling can be found in U.S. Pat. No. 7,484,774 (the '774 patent) entitled “Redundant Latch/Verifier for a Quick Connector,” which was granted on Feb. 3, 2009, the specification and drawings of which is incorporated herein in its entirety by reference.

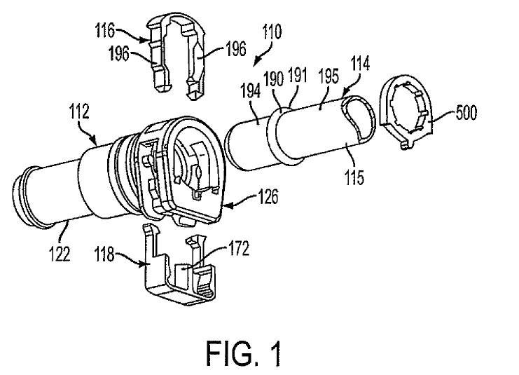

FIG. 1 illustrates a quick connector coupling 110 for forming a severable connection in a fluid line. The coupling 110 is comprised of a generally cylindrical female connector body 112 and a male member 114, to be releasably secured together by a primary retainer member 116. A redundant latch/verifier member 118 may also be employed. In many respects, the quick connector coupling 110 is similar to the structures disclosed in the '774 patent.

In use, the female connector body 112 is connected to a tubing or hose (not shown) which is also a part of the fluid line system. The female connector body 112 and the male member 114 are connectable to form a permanent, but severable, joint in the fluid line.

As illustrated in FIG. 1, the male member 114 is formed at the end of a rigid tube 115 having an outer cylindrical sealing surface 194. It includes a radially enlarged upset 190 defining a rearward facing radial annular abutment surface 191 at a predetermined distance from a free or open end 192 of the tube 115. Rearward outer cylindrical surface 195 of tube 115 extends rearward, away from upset 190.

The connector body 112 is illustrated in FIGS. 1-5. The connector body 112 is hollow and includes a generally cylindrical wall 120. It must be understood that the body exterior may take any desired shape without departing from the invention. It could, for example, include a 90° bend between its ends, which is a common shape for a connector body.

The connector body includes a stem portion 122 made of metal attached to a separate molded retainer housing 124 made of a plastic material, such as polyamide. Such a configuration is disclosed in U.S. Pat. No. 7,497,480 entitled “Hybrid Quick Connector,” which granted on Mar. 3, 2009, the specification and drawings of which are hereby incorporated herein by reference.

Referring to FIG. 4, the interior surface of wall 120 defines a through bore 126 from an entrance opening 127 at male member reception end 128 to hose connection end 130. It should be noted that the term axial and axially as used herein means longitudinally along the connector body wall 120. The terms lateral, laterally, transverse and transversely mean in a plane generally perpendicular to the longitudinal extent of body wall 120.

The bore 126 of connector body 112 extends completely through the connector body 112. Variations in the diameter of wall 120 of connector body 112 divide through bore 126 into distinct sections namely retainer housing section 132, seal chamber 134, and tube end receptacle 136. It should be noted that the term forward is used herein to mean in a direction axially from male member reception end 128 toward the hose connection end 130 generally along the central axis. The term rearward means in a direction axially from the hose connection end 130 toward the male member reception end 128 generally along the central axis.

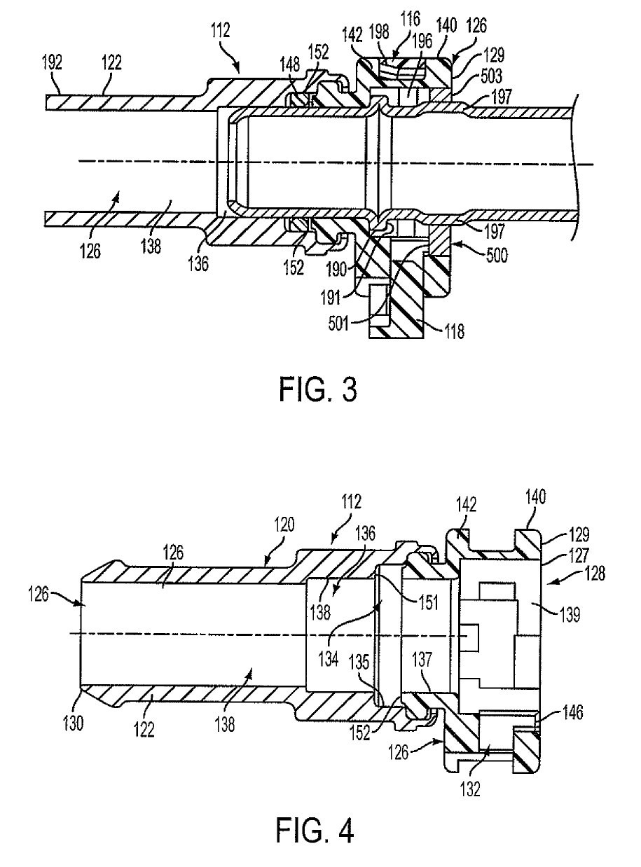

The retainer housing section 132 is adjacent to the male member reception end 128. The retainer housing section 132 is defined by a rim 140 having a transverse planar rearward facing surface 129 that defines the entrance hole or opening 127 to through bore 126 at the male reception end 128. Rim 140 is connected by several posts to forward rim 142. As seen in FIG. 3, the gap between rim 140 and forward rim 142 receives primary retainer 116 and secondary latch verifier 118, which operate to releasably secure male member 114 in the bore 126 of connector body 112 in a well known manner.

Bore 126 defines an axially extending stabilization ring support surface 139 at entrance opening 127. The bore 126 is sized to pass upset 190 on insertion of male member 114 into entrance opening 127 of body 116.

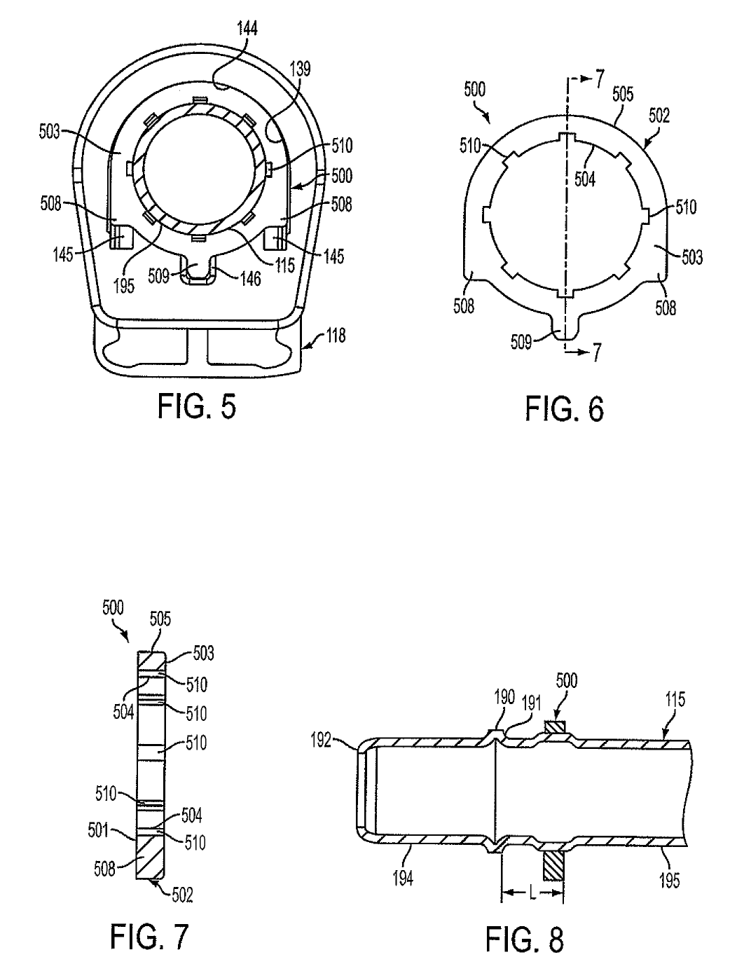

The shape of axially extending stabilization ring support surface 139 is best seen in FIG. 5. It is configured to receive and support stabilization ring or insert 500, described in detail below. The axial surface 139 includes a cylindrical or arcuate portion 144. It also defines a pair of notches in the form of outward extension cavities 145. It also defines radially outward central slot 146.

The tube end receptacle 136 is formed by a cylindrical bore surface 137 formed in the retainer housing section 124 and a coaxial bore surface 138 in stem portion 122. The tube end receptacle 136 is sized to receive, and pilot or guide the outer cylindrical surface 194 of tube 115 of male member 114.

Referring to FIG. 4, the seal chamber 134 is formed axially forward of the retainer housing section 132, It is defined by radial annular walls 151 and 152 of body 112 within bore 127 and axial cylindrical surface 135 in stem portion 122. It is sized to house sealing member 148 to form a fluid seal between the connector body 112 and the male member 114.

As illustrated in FIG. 3, the sealing member, in the form of an O-ring 148 is sized to fit tightly within the seal chamber 134 against cylindrical surface 135 and tightly around the outer cylindrical sealing surface 194 of the tube 115 defining male member 114. The O-ring 148 is restricted axially in the seal chamber 134 by radial annular walls 151 and 152.

The fluid passageway 138 is defined by the smallest diameter portion of wall 120. It defines the remainder of through bore 126.

It should be noted that for purpose of clarity, the quick connector coupling 110 is shown with its longitudinal extent positioned in a generally horizontal plane and the terms “top,” “bottom” and “sides” have been used in describing the connector body 116. It will be understood that the “top” configuration is associated with the primary retainer 116 and the bottom configuration is associated with the redundant latch/verifier 118 However, in use, the connector coupling 110 can reside in any orientation without regard to the horizontal and vertical planes and “top” and “bottom” are only relevant to the illustrations herein.

The primary “horse-shoe” type retainer 116 is illustrated in FIGS. 1 to 3. It is preferably molded of a resilient, flexible material, such as plastic. The primary retainer 116, which extends transversely through the top of retainer housing section 132 between rims 140 and 142, is demountably coupled to the connector body 112. It includes a pair of elongated, generally parallel spaced legs 196. The legs 196 are joined to and extend from cross member 198. The cross member 198 provides a separation between the legs 196 approximately equal to the outer diameter of the cylindrical tube 115 of male member 114. The arrangement of legs 196 with cross member 198 allows outward expansion of the legs 196 to permit male member insertion and release. When in the latched position, the legs 196 are in abutting relation between rearward radial annular abutment surface 191 of upset 190 of male member 190 and a forward surface of rim 140 as shown in FIG. 3. When so positioned, the legs prevent withdrawal of male member 114 from bore 126 of body 112. The cylindrical sealing surface 194 of tube 115 is disposed in cylindrical bores 137 and 138 and O-ring seal member 148 seals against surface 194. The bores 137 and 138 are sized slightly larger than the outer cylindrical sealing surface 194 of tube 115. The tube is thus supported against lateral movement.

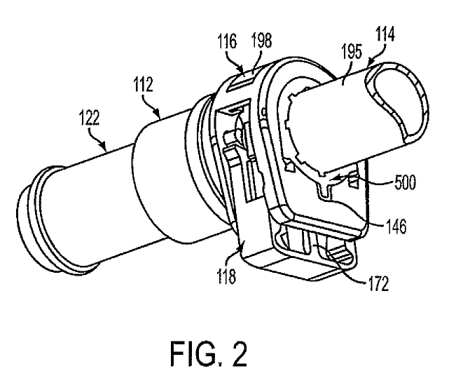

The redundant latch/verifier 118 is illustrated in FIGS. 1 and 2. It is configured as described in the previously identified U.S. Pat. No. 7,497,480.

The redundant latch/verifier 118 is molded of a resilient, flexible material, such as plastic. The redundant latch/verifier 118 is at the bottom of retainer housing section 132. It is slidable transversely of the connector body 112 toward and away from the through bore 126 between a radially inner, or latched, position and a radially outer, or unlatched, position. In its latched position it prevents inadvertent opening of primary retainer 116. In some applications, it could also include a radially slidable locking beam 172 as illustrated. When in the latched position, a surface of the beam 172 abuts the radial abutment surface 191 of upset 190 to prevent withdrawal of the tube 114 from connector body 112.

The redundant latch/verifier 118 is shown here only for purposes of illustration. It is not a necessary element of a quick connector coupling embodying the present invention.

In the illustrated embodiment, and as best seen in FIGS. 5 to 8, the stabilization ring or insert 500 of the coupling 110 is configured to reside between tube 115 and connector body 112 forward of entrance opening 127 and provide additional lateral or transverse support for tube 115 relative to body 112. It is a planar disc like element of short axial extent between forward planar surface 501 and rearward planar surface 503. Notably stabilization ring 500 is symmetrical. Hence, on installation, it need not be specifically oriented as to which planar surface of stabilization ring 500 is facing forward and which is facing rearward.

Insert 500 includes an outer perimeter surface 502 defining a generally cylindrical or arcuate segment 505 to coact with axially extending stabilization ring support surface 139 of retainer portion 132.

Ring 500 is configured to fill the void space between the rearward outer cylindrical surface 195 of tube 115 and axially extending stabilization ring support surface 139 of retainer portion 132 at entrance opening 127. The outer perimeter surface 502 of ring 500 has a shape to complement the shape of axially extending stabilization ring support surface 139. It includes protrusions 508 that extend radially outward and shaped to engage outward extension cavities 145 defined by surface 139. Perimeter surface 502 further defines a central protrusion 509 to reside within central radial slot 146 defined by axial surface 139 at entrance opening 127.

The perimeter surface 502 is sized slightly smaller than the perimeter of stabilization ring support surface 139 so that insert 500 fits snugly, but freely, within support surface 139. Thus, the insert 500 may be moved axially forward into position within axially extending stabilization ring support surface without any appreciable axial force required for such insertion. Yet, once so inserted, the perimeter surface 502 of the insert 500 coacts with surface 139 to resist lateral or transverse movement.

The stabilization ring 500 is functional upon insertion into the aperture defined by axially extending stabilization ring support surface 139 at entrance opening 127 of connector body 116 to preclude rotation of the stabilization ring 500 relative to the body 116. The outer axial surface 502 of ring 500 is supported within stabilization ring support surface 139 of the body 116. The protrusions 508 and 509 of ring 500 are disposed in extension cavities 145 and slot 146 in body 116 to prevent relative rotation.

Stabilization ring 500 includes a through bore defined by inner axial surface 504 to coact with rearward outer cylindrical surface 195 of tube 115. In the illustrated embodiment of FIGS. 1 to 8, inner axial surface 504 of stabilization ring 500 is generally cylindrical. It has a diameter slightly larger than the diameter of rearward outer cylindrical surface 195 of the tube 115. Inner axial surface 504 includes a series of radially outward notches 510 spaced about the surface. The notches 510 coact with the rearward outer cylindrical surface 195 of tube 115.

Notches 510 on inner axial surface 504 of stabilization ring 500 engage rearward outer cylindrical surface 195 of tube 115 rearward of radial annular abutment surface 191 of upset 190. It is contemplated that the stabilization ring 500 is attached to the rearward outer cylindrical surface 195 of tube 115 at the appropriate predetermined distance from upset 190 during the tube end forming process. The axial position of the ring 500 relative to the end of tube 115 and the radial upset 190 is first established and the tube expanded from within. On deformation of the tube 115 radially outward the tube deforms somewhat to engage notches 510 to secure the tube rearward outer cylindrical surface 195 to the inner axial surface 504 of the stabilization ring 500. The engagement with notches 510 serves to further enhance the gripping relation between the ring 500 and tube 115.

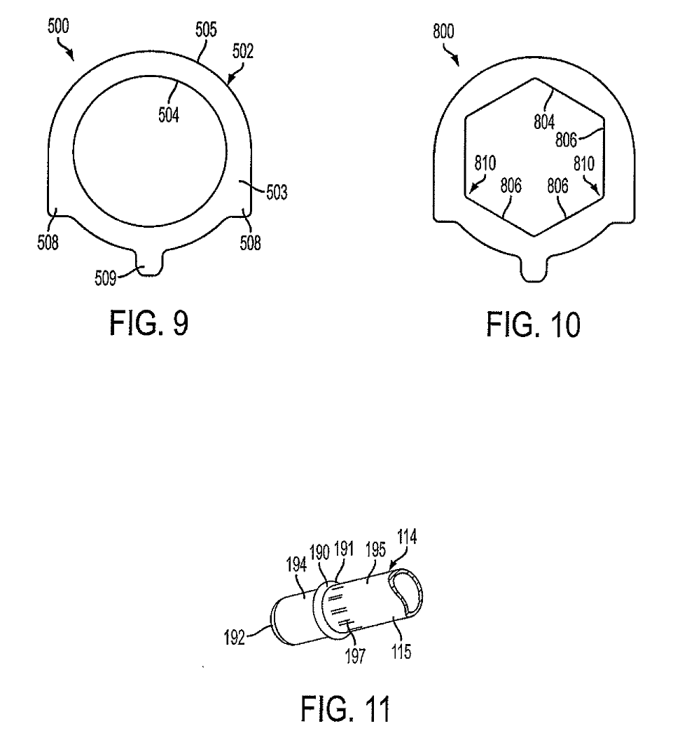

As illustrated in FIG. 9, the stabilization ring 500 may include a central bore with no notches formed on inner axial surface 504. Expansion of the rearward outer cylindrical surface 195 of tube 115 during the attachment process frictionally secures the stabilization ring 500 to tube 115.

As illustrated in FIG. 3, with the tube 115 fully inserted, that is, with upset 190 forward of legs 196 of primary retainer 116, the stabilization ring 500 is positioned in engagement with axially extending stabilization ring support surface 139 of bore 126 at entrance opening 127 to preclude rotation of tube 114 relative to ring 500. Protrusions 508 and 509 are engaged with outward extension cavities 145 and central radial slot 146 to preclude rotation of ring 500 relative to connector body 116.

Referring to FIG. 8, the upset 190 of tube 115 is formed to place radial annular abutment surface 191 a given distance from the free end of tube 115. That distance is such that the cylindrical sealing surface 194 is supported within bore surfaces 137 and 138 of tube end receptacle 136 with upset 190 positioned forward of legs 196 of retainer 116.

The insert or stabilization ring 500 is secured to rearward outer cylindrical surface 195 of tube 115 with rearward planar surface 503 positioned a distance “L” from the rearward radial annular abutment surface 191 such that with the tube fully inserted into the bore 126, the ring 500 is axially aligned within inner axial surface 139. This relationship locates the stabilization ring 500 within connector body 116 with forward planar surface 501 forward of transverse rearward facing surface 129 defining entrance opening 127 with perimeter surface 502 engaged with axially extending stabilization ring support surface 139.

It is contemplated that the stabilization ring 500 be attached to tube 115 at the described fixed location during the tube end forming step. As explained, the stabilization ring 500 is secured to tube 115 by expansion of the tube from within causing rearward outer cylindrical surface 195 to frictionally engage inner cylindrical surface 504. This expansion also establishes a gripping relation between notches 510 of stabilization ring 500 and rearward outer cylindrical surface 195 of tube 115.

The tube 115 with upset 190 properly formed and stabilization ring 500 properly located may then be inserted into the bore 126 of connector body 112 through entrance opening 127 at completion of the quick connector coupling assembly process.

When completed, the outer cylindrical sealing surface 194 resides in tube end receptacle 136 defined by surfaces 137 and 138, the seal member 148 resides in seal chamber 134 in sealing relation to surface 135 of bore 126 and outer cylindrical sealing surface 194 of tube 115. Upset 190 is positioned with radially annular abutment surface 191 axially forward of legs 196 of retainer 116. Stabilization ring 500 is disposed with outer perimeter surface 502 aligned within axially extending stabilization ring support surface 139. This latter relationship between the stabilization ring 500 and the body 112 provides support for tube 115 and resists lateral displacement of the tube 115 relative to the body 112. The fixed engagement of inner cylindrical surface 504 with the rearward outer cylindrical surface 195 of tube 115 resists rotational displacement of tube 115 relative to connector body 112.

In a quick connector coupling with no stabilization, the free end of tube 115 is piloted in tube receiving portion or receptacle 136 of bore 126. Also, seal member 148 provides some resistance to lateral or transverse movement of tube 115 relative to the body bore 126 since it is in sealing contact with the outer cylindrical surface 194 of the tube and the inner cylindrical surface 135 of bore 126 at seal chamber 134. However, there is no lateral support for tube 115 rearward of the tube end receptacle 136, for example adjacent the entrance opening 127 at male member reception end 128.

With the stabilization ring 500 of the present invention, the outer cylindrical surface 502 of stabilization ring 500 is in contact with the inner axially extending stabilization ring support surface 139 of body bore 126 at entrance opening 127. The inner cylindrical surface 504 of stabilization ring 500 is in contact with the rearward outer cylindrical surface 195 of tube 115. Any transverse loading of the tube 115 is transferred from tube 115 through stabilization ring 500 to connector body 116. This relationship enhances the capability of the coupling to resist misalignment.

It should be noted that the size of the inner cylindrical surface 504 of stabilization ring 500 is such that it cannot pass the upset 190 in tube 115. The ring 500 must be applied to the tube 115 prior to the end forming process to create the upset 190. Alternatively, the stabilization ring 500 may be assembled onto the tube 115 from its opposite end and slid into position adjacent upset 190.

The inert or stabilization ring 500 is fixed to the rearward outer cylindrical surface 195 of tube 115 prior to insertion of the male member 114 into connector body 112. Because the ring 500 is not rotatable relative to the tube 115, the orientation of the tube relative to the connector body is also fixed. This relationship is significant when it is important to control this rotational relationship such as in instances where the stem portion 122 is formed at an angle relative to the longitudinal axis of bore 126.

It is contemplated that the inner cylindrical surface 504 can take any form that resists rotation of the tube 115 relative to the stabilization ring 500. For example, as shown in FIG. 10, inner axial surface 804 of ring 800 is a hexagonal pattern defined by flats 806. It is contemplated that stabilization ring 800 would be appropriately positioned and secured to the tube 115 during the end forming process. The distance across flats 806 would be slightly larger than the diameter of rearward outer cylindrical surface 195 of tube 115. During the end forming process, the tube 115 would be expanded toward the corners 810 defined by adjacent flats 806. The tube 115 would thus be fixed against rotation relative to the stabilization ring 800.

It is also contemplated that the stabilization ring 500 be formed of a resilient material such as a polymeric rubber. When deformed, it would possess sufficient resiliency to provide a restoring force. The outer cylindrical surface 502 would be sized somewhat larger than the inner axially extending stabilization ring support surface 139 defined in bore 126 of body 116 at entrance opening 127. Insertion of the stabilization ring 500 would deform the ring 500 radially sufficiently to cause the inner cylindrical surface 502 to compress against with rearward outer cylindrical surface 195 of tube 115 thereby exerting a force to resist rotation of the tube 115 relative to the ring 500. An adhesive could also be applied between the rearward outer cylindrical surface 195 of tube 115 and inner axial surface 504 of stabilization ring 500.

Referring to FIG. 11, there is illustrated a modification to the rearward outer cylindrical surface 195 of tube 115 that augments the resistance to rotation of tube 115 relative to stabilization ring 500. Rearward outer cylindrical surface 195 includes a plurality of equally spaced radially outward ridges 197 or tube retention surfaces. These ridges are spaced to align with and be received in notches 510 of insert or stabilization ring 500. Ridges 197 may be formed in the tube 115 by any known process, such as, external “pinching” of the tube or expansion of the tube into a forming die.

The ridges are positioned relative to upset 191 such that when the tube 115 is fully inserted the stabilization ring 500 is disposed at the distance “L” from radial surface 191 of upset 190 and within the axially extending stabilization ring support surface 139.

1. A quick connector coupling comprising:
a connector body defining a through bore with an entrance opening at a male member reception end, said body defining an axially extending stabilization ring support surface at said male member reception end forward of said entrance opening, said connector body further defining a tube end receptacle forward of said axially extending stabilization ring support surface;
a male member comprising a tube having a free end and a radially enlarged upset spaced from said free end, a cylindrical sealing surface extending between said free end and said upset, and a rearward cylindrical surface rearward of said upset;
a stabilization ring surrounding said rearward cylindrical surface of said tube, said stabilization ring including an axially extending surface disposed within said axially extending stabilization ring support surface.

2. A quick connector coupling as claimed in claim 1 wherein said stabilization ring support surface is configured to receive and support said stabilization ring, and said stabilization ring includes an outer perimeter surface shaped to compliment the shape of the said axially extending stabilization ring support surface and is configured to fit freely but snugly within said axially extending stabilization ring support surface.

3. A quick connector coupling as claimed in claim 2 wherein said axially extending stabilization ring support surface defines at least one outward extension cavity and said outer perimeter surface of said stabilization ring defines at least one protrusion disposed in said at least one extension cavity.

4. A quick connector coupling as claimed in claim 3 wherein said axially extending stabilization ring support surface defines a plurality of extension cavities and said outer perimeter surface of said stabilization ring defines a protrusion disposed in each said extension cavity.

5. A quick connector coupling as claimed in claim 2 wherein said stabilization ring includes an inner cylindrical surface frictionally engaged with said rearward cylindrical surface of said tube.

6. A quick connector coupling as claimed in claim 5 wherein said inner cylindrical surface of said stabilization ring includes a series of radial outward notches spaced about said inner cylindrical surface.

7. A quick connector coupling as claimed in claim 5 wherein said rearward cylindrical surface of said tube is expanded radially outwardly into frictional engagement with said inner cylindrical surface of said stabilization ring.

8. A quick connector coupling as claimed in claim 6 wherein said rearward cylindrical surface of said tube is expanded radially outwardly into frictional engagement with said inner cylindrical surface of said stabilization ring.

9. A quick connector coupling a claimed in claim 2 wherein said outer perimeter surface of said stabilization ring is sized slightly smaller than said axially extending stabilization ring support surface so as to fit freely therein.

10. A quick connector coupling as claimed in claim 9 wherein said stabilization ring is made of metal.

11. A quick connector coupling as claimed in claim 7 wherein said outer perimeter surface of said stabilization ring is sized slightly smaller than said axially extending stabilization ring support surface so as to fit freely therein.

12. A quick connector coupling as claimed in claim 11 wherein said stabilization ring is made of metal.

13. A quick connector coupling as claimed in claim 2 wherein said body includes at least one cylindrical bore surface defining said tube end receptacle, and said body defines a retainer housing section between said at least one cylindrical bore surface and said axially extending stabilization ring support surface, said coupling including a retainer in said retainer housing section having spaced legs, said outer cylindrical sealing surface of said tube disposed in said at least one cylindrical bore surface, said upset includes a rearward radial annular abutment surface in abutting relation to said legs, and said stabilization ring including a forward planar surface and a rearward planar surface, said stabilization ring is disposed a distance “L” from said rearward radial annular abutment surface such that said forward planar surface is forward of said entrance opening defined by said body with said outer perimeter surface of said stabilization ring is within said axially extending stabilization ring support surface of said connector body.

14. A quick connector coupling as claimed in claim 13 wherein said stabilization ring includes an inner cylindrical surface frictionally engaged with said rearward cylindrical surface of said tube.

15. A quick connector coupling as claimed in claim 14 wherein said inner cylindrical surface of said stabilization ring includes a series of radial outward notches spaced about said surface.

16. A quick connector coupling as claimed in claim 13 wherein said axially extending stabilization ring support surface defines at least one outward extension cavity and said outer perimeter surface of said stabilization ring defines at least one protrusion disposed in said at least one extension cavity.

17. A quick connector coupling as claimed in claim 16 wherein said axially extending stabilization ring support surface defines a plurality of extension cavities and said outer perimeter surface of said stabilization ring defines a protrusion disposed in each said extension cavity.

18. A method of forming a male member for a quick connector coupling said male member comprising a rigid tube having a free end and a radially enlarged upset spaced from said free end a cylindrical sealing surface extending between said free end and said upset and a rearward cylindrical surface rearward of said upset, and a stabilization ring secured to said rearward cylindrical surface rearward of said upset, the steps comprising:
providing a rigid tube having a free end and an outer cylindrical surface;
providing a stabilization ring having an outer perimeter surface and an inner axial surface,
positioning said stabilization ring on said cylindrical surface of said tube;
forming said upset with a rearward radial annular abutment surface a given distance from said free end of said tube;
positioning said stabilization ring a predetermined distance from said rearward annular abutment surface;
expanding said tube to secure said stabilization ring to said rearward cylindrical surface.

19. A method as claimed in claim 18 wherein said inner axial surface of said stabilization ring is generally cylindrical and includes a series of radially outward notches spaced about said surface, the steps further comprising:
expanding said tube to cause said rearward cylindrical surface of said tube to engage said notches.

20. A method for resisting relative rotation in a fluid coupling between a male member and a connector body having a tube receiving bore and defining an axially extending stabilization ring support surface, the method comprising:
providing a stabilization ring and securing said stabilization ring to said male member;
inserting said male member into said tube receiving bore;
thereby engaging said stabilization ring with said axially extending stabilization ring support surface.

21. The method of claim 20, further including providing at least one protrusion on an exterior surface of said stabilization ring, and providing an outward extension cavity defined in said connector body by said stabilization ring support surface, the steps further comprising disposing said at least one protrusion in said extension cavity.

22. The method of claim 21, wherein said stabilization ring is made of a rigid material, and wherein engaging said male member with said stabilization ring includes expanding a portion of said male member into engagement with an inner axial surface of said stabilization ring.
